(19) United States
(12) Patent Application Publication
(10) Pub. No.: US 2004/0037599 A1
(43) Pub. Date: Feb. 26, 2004

(54) Image forming apparatus

(76) Inventors: Takashi Serizawa, Tokyo (JP); Hiroaki Sato, Tokyo (JP)

Correspondence Address: RABIN & Berdo, PC, 1101 14TH STREET, NW, SUITE 500, WASHINGTON, DC, 20005, US

(21) Appl. No.: 10/642,579

(22) Filed: Aug. 19, 2003

(30) Foreign Application Priority Data
Aug. 20, 2002 (JP) JP2002-239186

(51) Int. Cl. G03G 21/00

(52) U.S. Cl. 399/350

(57) ABSTRACT

The present invention provided an image forming apparatus which is small-sized and is able to keep a longtime and stable cleaning function. The image forming apparatus comprises a image carrier; a blade member contacting elastically with the image carrier; a semi-conductive member installed on the blade member; and a power unit for adding a voltage to the semi-conductive member. Further, the semi-conductive member is set apart from the contacting portion of the blade member by a predetermined isolation distance.

### BACKGROUND OF THE INVENTION

1. Field of the Invention

The invention relates to an image forming apparatus.

2. Related Background Art

Conventionally, In image forming apparatus, for example, printing apparatus with electrophotography, copying apparatus or facsimile apparatus, in order to form an image, first forming a electrostatic latent image on a photoconductor drum by using a electrifying device to electrify the surface of the photoconductor drum and using a LED (Light Emitting Diode ) head to expose the surface of the photoconductor drum, then forming a toner image by using an image developing device made up of a blade and a developing roller and the like to developing the electrostatic latent image, further transferring the toner image on recording medium, for example, sheet or film by using a transference device, moreover forming an image by using a fixing device to fix the toner image transferred on the recording medium.

FIG. 2 is a summary drawing showing the main part of a conventional image forming apparatus.

In the FIG. 2, 11 is a photoconductor drum set rotating-freely along an arrow direction, 12 is a electrifying device to electrifying the uniformly and equally the photoconductor drum. The electrifying device comprises a electrifying roller 13 which contacts with the photoconductor drum 11 and is set rotating-freely, and a power unit 14 supplying a surface electric potential of −700V to the electrifying roller 13.

Further, 15 is a cleaning device for removing the toner (hereinafter: residual toner) remaining on the surface of the photoconductor drum 11. The cleaning device 15 comprises a cleaning blade 16 forming from a elastic material for example Urethane rubber, a bracket 17 for supporting the cleaning blade 16. The cleaning blade 16 has a JIS hardness of 60 degrees, a thickness of 2.0 mm, and a projecting portion with a length of 9.5 mm, projecting from the tip of the bracket 17. Further, the cleaning blade 16 has a slant angle H (53.4° ) with respect to the line extending from the center of the photoconductor drum along the radial direction and is pressed with a predetermined pressure by the photoconductor drum 11. Thus, while the photoconductor drum 11 rotates, the residual toner is scraped away by the cleaning device. Moreover, the photoconductor drum 11, the electrifying device 12 and the cleaning device 15 construct the image forming apparatus.

When the image forming apparatus starts to be used, in order to preventing the tip of the cleaning blade 16 from being rolled up, the toner with insulation efficiency is previously smeared on the tip of the cleaning blade 16. Thus, the early torque of the photoconductor drum 11 becomes small.

However, because the electrifying device 12 and the cleaning device 15 are set in the conventional image forming apparatus, the image forming apparatus becomes big.

Therefor, a cleaning blade which has an electrifying function for electrifying the surface of the photoconductor drum and a cleaning function for removing the residual toner is provided (refer to the Japanese Patent Publication No. 6-130778).

FIG. 3 is a summary drawing showing the main part of a conventional image forming apparatus.

In the FIG. 3, 11 is a photoconductor drum set rotating-freely along an arrow direction, 21 is an electrifying/cleaning device for, while electrifying the uniformly and equally the photoconductor drum 11, removing the residual toner after transferring. The electrifying/cleaning device 21 comprises a cleaning blade 22 with semi-conductivity, a bracket 23 for supporting the cleaning blade 22, and a power unit 24 supplying a predetermined voltage to the cleaning blade 22 so that the photoconductor drum 11 has a predetermined surface electric potential.

The cleaning blade 22 is formed by mixing the conductive particles, for example, carbon black into Urethane rubber serving an elastic material, and has a cubic resistance of 10⁶-10⁹ (Ω·cm).

However, in the other conventional image forming apparatus, when performing continually printings, the edge portion of the cleaning blade 22 is worn away so that to be nicked. Thereby, it is impossible to keeping a cleaning function. This can be considered that the hardness of the rubber drops so that the durability of the cleaning blade 22 is gone.

### SUMMARY OF THE INVENTION

To solve the conventional problems as mentioned above, the present invention supplies an image forming apparatus not only capable of becoming small-sized, but also capable of keeping a longtime cleaning function.

According to the invention, there is provided an image forming apparatus, comprising:

an image carrier;

a blade member having a contacting portion contacting elastically with the image carrier;

a semi-conductive member installed on the blade member; and

a power unit for adding a voltage to the semi-conductive member,

wherein the semi-conductive member is set apart from the contacting portion of the blade member by a predetermined isolation distance Lb.

In the image forming apparatus, the isolation distance Lb may be set as follows:

0<Lb≦1.0 mm.

Further, the isolation distance Lb may be set as follows:

0.7<Lb≦0.8 mm.

Moreover, the semi-conductive member may be a tape with semi-conductivity, also, the semi-conductive member may be a resin plate with semi-conductivity.

The above and other objects and features of the present invention will become apparent from the following detailed description and the appended claims with reference to the accompanying drawings.

### BRIEF DESCRIPTION OF THE DRAWINGS

FIG. 1 is a summary drawing showing the main part of a printer of the present invention in embodiment 1;

FIG. 2 is a summary drawing showing the main part of one conventional image forming apparatus;

FIG. 3 is a summary drawing showing the main part of the other conventional image forming apparatus;

FIG. 4 is a summary drawing showing a printer of the present invention in embodiment 1;

FIG. 5 is an expanding drawing showing the main part of a printer of the present invention in embodiment 1;

FIG. 6 is a front drawing showing the main part of a printer of the present invention in embodiment 1;

FIG. 7 is an explanation diagram showing a relation between the isolation distance and the printing state in embodiment 2;

FIG. 8 is a front drawing showing the main part of a printer of the present invention in embodiment 2; and

FIG. 9 is a summary drawing showing the main part of a printer of the present invention in embodiment 3.

### DETAILED DESCRIPTION OF THE PREFERRED EMBODIMENTS

With respect to embodiments of the present invention, while referring to diagrams, the following is to explain them in detail.

In embodiments, serving as an image forming apparatus, a printer which performs a printing i.e. image formation with respect to a printing medium.

<Embodiment 1>

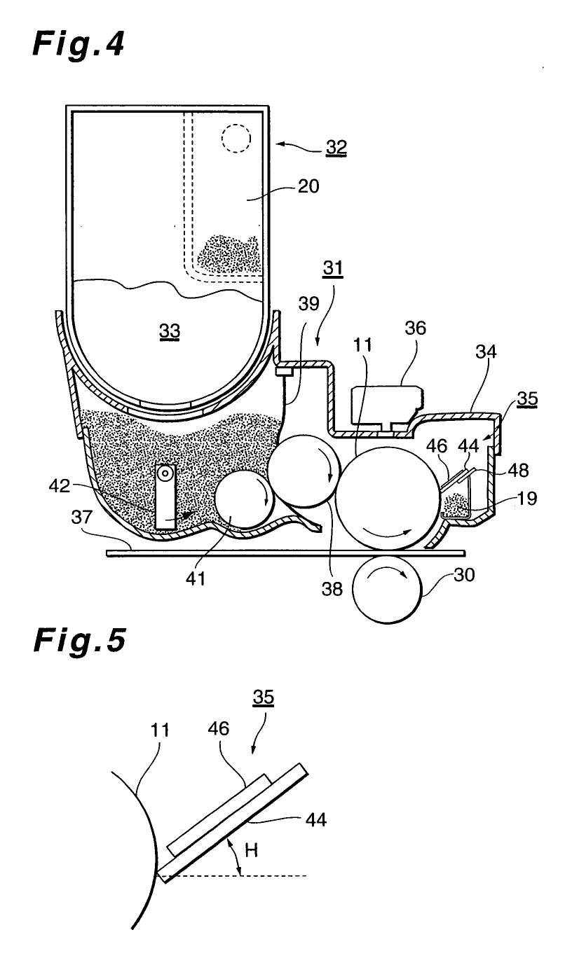

FIG. 4 is a summary drawing showing a printer of the present invention in embodiment 1.

In the FIG. 4, 31 is a cartridge, 32 is a toner accommodating section set on the cartridge 31 for accommodating the toner 33, 37 is a recording medium like paper or OHP sheet. The cartridge 31 comprises a case 34, a photoconductor drum 11 serving as a image carrier set such as rotating freely along an arrow direction, an electrifying/cleaning device 35 for, while electrifying the uniformly and equally the photoconductor drum 11, removing the residual toner after transferring, a image developing roller 38 which is set such as contacting with the photoconductor drum 11 and serves as a toner carrier rotating along an a arrow direction, an image developing blade 39 which is pressed by the image developing roller 38 and is used to form a thin layer of the toner 33 on the surface of the image developing roller 38, a toner providing roller 41 which is set such as contacting with the image developing roller 38 and serves as a toner providing member rotating along an arrow direction, a stirring rod 42 which rotates along an arrow direction and supplies the toner 33 that dropped from the toner accommodating section 32 to the toner providing roller 41. Moreover, by the image developing roller 38, the image developing blade 39, the toner providing roller 41, the stirring rod 42, and other, an image developing device is formed.

Further, on the case 34, a LED head 36 serving as a exposing device is set such as facing to the photoconductor drum 11, under the case 34, a transferring roller 30 which is set such as rotating freely along an arrow direction and contacting with the photoconductor drum 11, and is used to construct a transferring device. Moreover, the cartridge 31, the LED head 36, the transferring roller and others constructed a printer.

In the printer, or example, the surface of photoconductor drum 11 is electrified uniformly and equally, then, a electrostatic latent image is formed on the exposed photoconductor drum 11 by the LED (Light Emitting Diode) head 36. Further, a toner image is formed on the photoconductor drum 11 by using the image developing device to developing the electrostatic latent image. Moreover, the toner image is transferred on the recording medium 37 by using the transferring roller 30. Then, the recording medium 37 is sent to a fixing device (not shown) for fixing the toner image on the recording medium 37. Thus, the printing is performed.

After the toner image is transferred, the residual toner remaining on the surface of the photoconductor drum 11 is scraped away by the electrifying/cleaning device 35, then serving as waste toner 19, is accommodated into the waste toner room 20 as a part of of the toner accommodating section 32.

As described above, in this embodiment, because the electrifying/cleaning device 35 not only has the electrifying function, but also has the cleaning function, no need to set a electrifying roller. Therefore, it is possible to make the printer become small-sized and to reduce the cost of the printer.

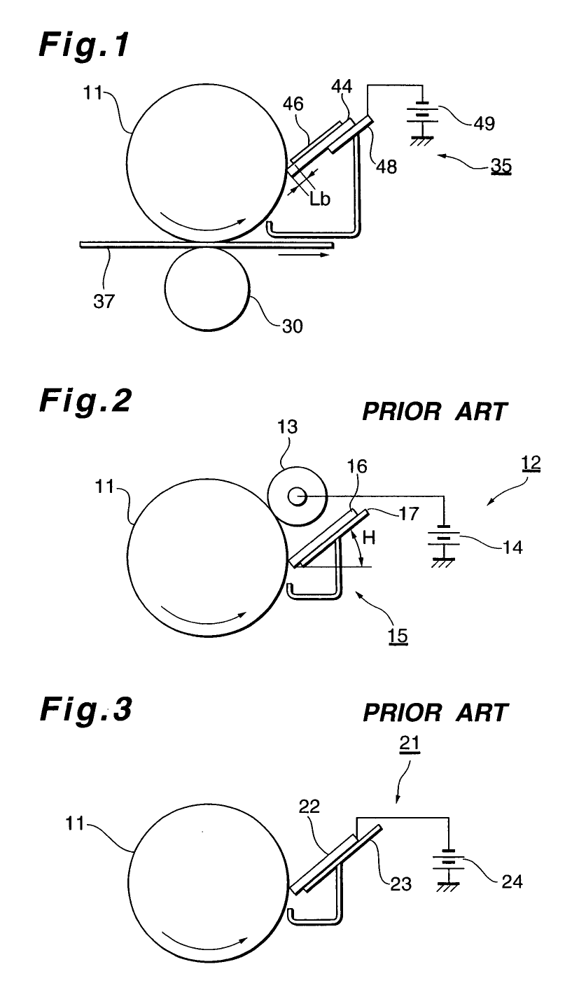

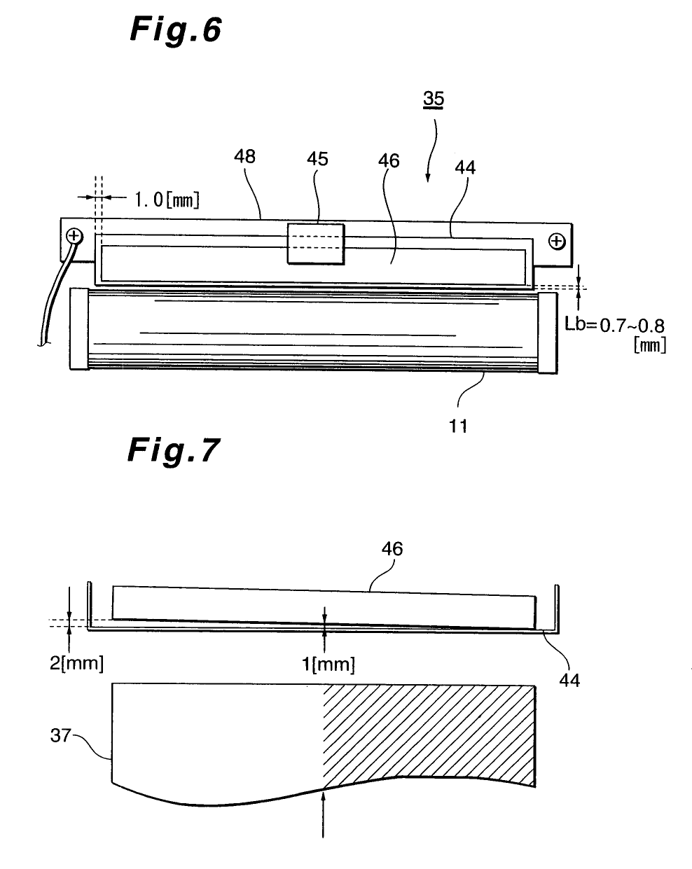

FIG. 1 is a summary drawing showing the main part of a printer of the present invention in embodiment 1; FIG. 5 is an expanding drawing showing the main part of a printer of the present invention in embodiment 1; FIG. 6 is a front drawing showing the main part of a printer of the present invention in embodiment 1; and FIG. 7 is an explanation diagram showing a relation between the isolation distance and the printing state.

In these drawings, 11 is a photoconductor drum, 30 is transferring roller, 35 is a electrifying/cleaning device.

The electrifying/cleaning device 35 comprises a cleaning blade 44 which serves as a blade member and whose tip is set such as contacting elastically with the photoconductor drum 11; a bracket 48 which serves as a supporting member for supporting the cleaning blade 44 and is made up of metal like steel plate; a power unit 49 of direct current for supplying a predetermined voltage to the photoconductor drum 11 so that the photoconductor drum 11 has a predetermined surface electric potential; a tape 46 with semi-conductivity serving as a semi-conductive member stuck on the cleaning blade 44; and a conductive tape 46 which is made up of a conductive material and is connected electrically with the bracket 48 and the tape 46 with semi-conductivity.

In the embodiment, the tape 46 with semi-conductivity is installed such as be stuck on the cleaning blade 44. Replacing it, the tape 46 may be installed by other means, for example, fixing means using a fixing member, joining means using a joining member, or fusing means using fusing member. Moreover, the power unit 49 adds a predetermined voltage to the bracket 48 so that the photoconductor drum 11 is added a predetermined voltage.

Further, in the embodiment, the tip of the cleaning blade 44 contacts with the photoconductor drum 11. With respect to the tip of the cleaning blade 44, it may be formed such as having a curve shape, then, its curve surface may contacts with the photoconductor drum 11.

Moreover, the cleaning blade 44 has a JIS hardness of 60 degrees, a thickness of 2.0 mm, and a projecting portion with a length of 9.5 mm, projecting from the tip of the bracket 48. Further, the cleaning blade 16 has a slant angle H (53.4°) with respect to the line extending from the center of the photoconductor drum along the radial direction and is pressed with a predetermined pressure by the photoconductor drum 11. Thus, while the photoconductor drum 11 rotates, the residual toner is scraped away by the cleaning device.

In this embodiment, in order to make the cleaning blade 44 contact elastically with the photoconductor drum 11, the cleaning blade 44 is formed by an elastic member. Replacing it, using a spring or the like, it is possible to make the cleaning blade 44 have elastic function. In this case, it is not necessary to form the cleaning blade by a elastic member.

The cleaning blade 44, being different from the conventional cleaning blade 16 (refer to FIG. 2), does not contain conductive particle. Therefore, the cleaning blade 44 has a very bigger cubic resistance than that of the tape 46 with semi-conductivity, for example, more than 10¹² (Ω·cm). Serving as a elastic material, the synthetic resin with a cubic resistance of 10¹² (Ω·cm) can be used so as to replace the Urethane rubber. Further, the tape with semi-conductivity 46 is formed from such semi-conductive material with a cubic resistance of 10⁶-10⁹ (Ω·cm) as PTFE (polytetrafluoroethylene) mixed with carbon black.

Moreover, in the embodiment, the power unit 49 generates a negative voltage of −1300V, the voltage is added to the bracket 48, the conductive tape 45, the tape 46 with semi-conductivity, and the photoconductor drum 11 via the cleaning blade 44. Thus, the photoconductor drum 11 is electrified equally and uniformly, and its surface electric potential becomes −70V.

Further, with respect to the sticking position of the tape 46 with semi-conductivity, is set at such position as being able to prevent from a short circuit between the photoconductor drum 11 and the tape 46 with semi-conductivity and to prevent the toner from stuffing between the tip of the tape 46 with semi-conductivity and the cleaning blade 44, and as being able to electrifying the photoconductor drum 11 sufficiently. That is, the tip of the tape 46 with semi-conductivity is set away at a predetermined isolation distance Lb (edge distance) from the tip i.e. the contacting portion contacting with the photoconductor drum 11, of the cleaning blade 44.

By using the electrifying/cleaning device 35 having the above-described construction, when the photoconductor drum 11 rotates along an arrow direction, the residual toner on the photoconductor drum 11 is scraped away by the cleaning blade 44 pressed by the photoconductor drum 11. Further, when the bracket 48 is added by a voltage of −1300V, the electron moves to the photoconductor drum 11 through the bracket 48, the conductive tape 45, the tape 46 with semi-conductivity, and the cleaning blade 44. Thus, the photoconductor drum 11 can be electrified equally and uniformly.

When sticking the tape 46 with semi-conductivity, it is necessary to make the tape 46 do not occur wrinkle. Thus, it is possible to improve the image quality.

By the way, in the embodiment, the edge distance Lb can be set within 0-1.0 mm, that is: 0<Lb≦1.0 mm. Thus, it is possible to keep the image quality. Further, it is desired to set the Lb within 0.7-0.8 mm, that is: 0.7≦Lb≦0.8 mm.

With respect to the setting of the Lb, an experimentation is performed. In the experimentation, as shown by FIG. 7, sticking the tape 46 on the cleaning blade 44 such as tilting the tape 46 with respect to the cleaning blade 44, and setting the isolation distance Lb at one edge by 2 mm and setting the isolation distance at the other edge by about 0 mm. Further, adding a voltage of −1300V to the bracket 48. Then, a printing is performed. In the printing, at the right area from the center of the recording medium 37, a normal printing is performed (normal printing), however, at the left area from the center of the recording medium 37, a abnormal printing is performed (abnormal printing). Thereby, it is proved that the part of the photoconductor drum 11, corresponding to the right area, is electrified normally, and the part of the photoconductor drum 11, corresponding to the left area, is electrified abnormally.

Because the isolation distance Lb at the center position of the recording medium 37 is about 1 mm, so when the Lb is set within 0-1.0 mm, it is seen that the photoconductor drum 11 is electrified normally.

The following can be considered. That is:

When the bracket 48 is added by a voltage of −1300V, as stated above, the electron moves to the photoconductor drum 11 through the bracket 48, the conductive tape 45, the tape 46 with semi-conductivity, and the cleaning blade 44. Because of this, when the isolation distance Lb is bigger than 1 mm, the resistance of the cleaning blade 44 between the tip of the tape 46 with semi-conductivity and the photoconductor drum 11 changes into bigger.

Thus, the electron can not be infused sufficiently to the photoconductor drum 11.

Further, in order to prevent from a short circuit between the tape 46 with semi-conductivity and the photoconductor drum 11, the two edges of the cleaning blade 44 are set away at a distance of 1 mm from the two edges of the tape 46. Then, with respect to the conductive tape 45, because it is connected electrically with the bracket 48 and the tape 46, so it can be set at any one of positions along the axis direction of the bracket 48 or the tape 46. In the embodiment, the conductive tape 45 is set at a center position. Moreover, in order to electrifying equally and uniformly the photoconductor drum 11, it is necessary to make the conductive tape 45 have a sufficient width.

However, in the embodiment, when forming the cleaning blade 44, because the conductive particles such as carbon black do not be mixed into the Urethane rubber, it is possible to prevent the hardness of the rubber from dropping so that the durability of the cleaning blade 22 can be kept. Therefore, even if performing continually printings, the edge portion of the cleaning blade 22 is not worn away so that to be not nicked. Thereby, it is possible to keeping a longtime and stable cleaning function.

Further, in the embodiment, because the pole of the voltage adding on the cleaning blade 44 is negative, so that being the same as that of the toner, it is possible to prevent the toner from sticking on the tip of the cleaning blade 44.

<Embodiment 2>

Next, to explain the embodiment 2 of the present invention.

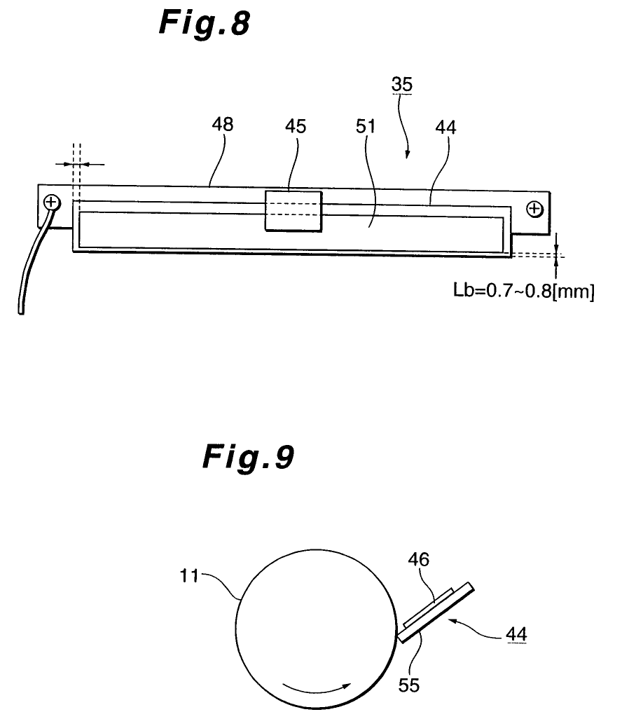

FIG. 8 is a front drawing showing the main part of a printer of the present invention in embodiment 2.

In this embodiment, on the cleaning blade 44, a resin plate 51 with semi-conductivity formed from a semi-conductive material having a cubic resistance of 10⁶-10⁹ (Ω·cm) is stuck. The resin plate 51 is formed such as having a thickness of 0.1 mm. If the resin plate 51 becomes very thick, there is a possibility to hurt the photoconductor drum 11 (FIG. 4), so it is desired to thin set the resin plate 51.

Because the resin plate 51 with semi-conductivity has a plate shape, not only possibly preventing the occurrence of bad manufacture, but also possibly prevent the occurrence of wrinkle while sticking on the cleaning blade 44. Therefore, while keeping easily the parallel state between the edge of the resin plate 51 with semi-conductivity and the edge of the cleaning blade 44, the isolation distances at each position along the axis direction of the resin plate 51 or the cleaning blade can easily become same.

As a result, because the waste toner 19 does not stick on the tip of the cleaning blade 44, it is possible to improve the electrification of the photoconductor drum 11. Therefore, it is possible to perform correctly the printing.

<Embodiment 3>

In order to more improve the quality of image, next, to explain the embodiment 3.

FIG. 9 is a summary drawing showing the main part of a printer of the present invention in embodiment 3.

In this embodiment, on the tip of the cleaning blade 44, semi-conductive particles (not shown) are smeared. Thus, when the photoconductor drum 11 rotates along the arrow direction, the semi-conductive particles are also smeared on the surface of the photoconductor drum 11.

Thereby, the friction between the photoconductor drum 11 and the tip of the cleaning blade 44 becomes small. Thus, the load on the tip of the cleaning blade 44 becomes small. Therefore, even if using the printer for a longtime and using the recording mediums beyond predetermined count, it is impossible to hurt the edge portion of the cleaning blade 44.

Further, because the pressure generated by the photoconductor drum 11 pressing the tip of the cleaning blade 44, is constant, so the scraping function for scraping away the residual toner and the electrification function for electrifying the photoconductor drum 11 do not change.

According to the present invention, the image forming apparatus comprises a image carrier; a blade member contacting elastically with the image carrier; a semi-conductive member installed on the blade member; and a power unit for adding a voltage to the semi-conductive member.

Further, the semi-conductive member is set apart from the contacting portion of the blade member by a predetermined isolation distance Lb.

In the present invention, because the electrifying/cleaning device has the electrifying function and the cleaning function, it is possible to make the image forming apparatus become small and to reduce the cost of the image forming apparatus.

Moreover, because the semi-conductive member is installed on the blade member, when the blade member is formed by a elastic member, it is possible to make the elastic member contain no conductive particles. Thus, it is possible to prevent the hardness of the rubber from dropping so that the durability of the blade member can be kept. Therefore, even if performing continually printings, the edge portion of the blade member is not worn away so that to be not nicked. As a result, it is possible to keeping a longtime and stable cleaning function.

The present invention is not limited to the foregoing embodiments but many modifications and variations are possible within the spirit and scope of the appended claims of the invention.

What is claimed is:

1. An image forming apparatus, comprising:
an image carrier;
a blade member having a contacting portion contacting elastically with said image carrier;
a semi-conductive member installed on said blade member; and
a power unit for adding a voltage to said semi-conductive member.
wherein said semi-conductive member is set apart from said contacting portion of said blade member by a predetermined isolation distance Lb.

2. The image forming apparatus according to claim 1, wherein said isolation distance Lb is set as follows:
0<Lb≦1.0 mm.

3. The image forming apparatus according to claim 1, wherein said isolation distance Lb is set as follows:
0.7<Lb≦0.8 mm.

4. The image forming apparatus according to claim 1, wherein said semi-conductive member is a tape with semi-conductivity.

5. The image forming apparatus according to claim 1, wherein said semi-conductive member is a resin plate with semi-conductivity.
